(19) United States
(12) Patent Application Publication
(10) Pub. No.: US 2018/0083315 A1
(43) Pub. Date: Mar. 22, 2018

(54) Coated Cathode Active Material for Engineered Solid-State Battery Interfaces

(71) Applicant: Robert Bosch GmbH, Stuttgart (DE)

(72) Inventors: John F. Christensen, Elk Grove, CA (US); Boris Kozinsky, Waban, MA (US); Sondra Hellstrom, East Palo Alto, CA (US)

(21) Appl. No.: 15/704,124

(22) Filed: Sep. 14, 2017

Related U.S. Application Data
(60) Provisional application No. 62/395,491, filed on Sep. 16, 2016.

(51) Int. Cl. H01M 10/0565; H01M 10/0525; H01M 4/525

(52) U.S. Cl. CPC H01M 10/0565; H01M 2004/028; H01M 4/525; H01M 10/0525

(57) ABSTRACT

A solid-state lithium-ion battery includes an anode, a cathode, and a separator. The cathode includes an active material, a catholyte material, and a barrier layer coating only the active material. The barrier layer is configured to isolate physically the active material from direct contact with the catholyte material and to connect ionically the active material and the catholyte material. The separator is located between the anode and the cathode and is configured to connect ionically the anode and the cathode and to isolate electronically the anode and the cathode.

This application claims the benefit of priority of U.S. provisional application Ser. No. 62/395,491, filed on Sep. 16, 2016, the disclosure of which is herein incorporated by reference in its entirety.

### FIELD

This disclosure relates to the field of lithium-ion batteries and in particular to solid-state lithium-ion batteries.

### BACKGROUND

Rechargeable lithium ion (“Li-ion”) batteries are attractive energy storage systems for portable electronics and electric and hybrid-electric vehicles because of their high specific energy compared to other electrochemical energy storage devices. A typical Li-ion battery cell contains a negative electrode, a positive electrode, and a separator region between the negative and positive electrodes. Both electrodes contain active materials that insert or react with lithium reversibly. In some cases, the negative electrode may include lithium metal, which can be electrochemically dissolved and deposited reversibly. The separator typically contains an electrolyte with a lithium cation and serves as a physical barrier between the electrodes, such that none of the electrodes are electronically connected within the cell.

Solid-state lithium-ion batteries contain electrolytes in the electrodes and/or the separator that are solid at an operating temperature of the battery. Solid-state lithium-ion batteries, in contrast to conventional lithium-ion batteries containing liquid electrolytes, have several advantages. The replacement of liquid electrolytes by solid-state electrolytes makes it possible, for example, to reduce the risk of thermal runaway and to increase the safety and the cycle stability of the battery.

The replacement of liquid electrolytes with solid electrolytes typically reduces the energy storage capacity of the cathode. For example, most known solid-state lithium-ion batteries have significant interfacial issues, such as degradation and high electrical resistance between the cathode and the catholyte.

For at least these reasons, further developments in the area of solid-state lithium-ion batteries are desirable.

### SUMMARY

According to an exemplary embodiment of the disclosure, a solid-state lithium-ion battery includes an anode, a cathode, and a separator. The cathode includes an active material, a catholyte material, and a barrier layer coating only the active material. The barrier layer is configured to isolate physically the active material from direct contact with the catholyte material and to connect ionically the active material and the catholyte material. The separator is located between the anode and the cathode and is configured to connect ionically the anode and the cathode and to isolate electronically the anode and the cathode.

According to another exemplary embodiment of the disclosure, a coated cathode of a solid-state energy storage device includes catholyte material, an active material, and a barrier layer. The active material is dispersed through the catholyte material. The barrier layer coats one of the catholyte material and the active material. The barrier layer is configured to isolate physically the active material from direct contact with the catholyte material and to connect ionically the active material and the catholyte material. The coated cathode electrode, which is also referred to herein as a composite cathode, may also include electronically conductive additives, such as carbon black and/or carbon fibers, and a polymeric binder (e.g., PVDF).

### BRIEF DESCRIPTION OF THE FIGURES

FIG. 1 is a cross-sectional block diagram of a solid-state lithium-ion battery cell, as disclosed herein, that includes cathode active material coated with a barrier layer, the coated cathode active material is shown in a greatly enlarged state as compared to the other components of the battery for explanatory purposes;

FIG. 2A is a cross-sectional block diagram illustrating the cathode active material, the barrier layer, and an ionically conductive material of the battery cell of FIG. 1;

FIG. 2B is a chart illustrating a suitability of cathode active materials and barrier layer materials;

FIG. 3 is a chart illustrating a stability calculation for certain barrier layer materials;

FIG. 4 is a phase diagram for lithium (“Li”), sulfur (“S”), and phosphorus (“P”) showing compounds/materials having a stable electrochemical state;

FIG. 5 is a diagram illustrating desired ion and electron transmission parameters;

FIGS. 6A and 6D show scanning electron microscope views of uncoated nickel cobalt manganese oxide (“NCM”), which is an exemplary cathode active material, FIGS. 6B, 6C, 6E, and 6F show the NCM coated with an exemplary barrier layer material provided as Li₃PO₄;

FIG. 7 is a chart showing the X-ray photoelectron spectroscopy (“XPS”) spectrum of the coated cathode active material of FIGS. 6B, 6C, 6E, and 6F;

FIGS. 8A and 8C show scanning electron microscope views of uncoated NCM, which is an exemplary cathode active material, FIGS. 8B and 8D show the NCM coated with an exemplary barrier layer material provided as LiNbO₃;

FIG. 9 is a chart showing an XPS spectrum of the coated cathode active material of FIGS. 8B and 8D;

FIG. 10A is a chart illustrating charge transfer resistance of exemplary uncoated cathode active materials and coated cathode active materials;

FIG. 10B is a chart illustrating electrical resistance of the solid-electrolyte interphases (“SEI”) for exemplary coated and uncoated cathode active materials;

FIG. 10C is a chart illustrating discharge capacity normalized to the first C/10 discharge versus discharge rate for exemplary coated and uncoated cathode active materials; and

FIG. 11 is a cross-sectional block diagram of another solid-state lithium-ion battery cell, as disclosed herein.

### DETAILED DESCRIPTION

For the purpose of promoting an understanding of the principles of the disclosure, reference will now be made to the embodiments illustrated in the drawings and described in the following written specification. It is understood that no limitation to the scope of the disclosure is thereby intended. It is further understood that this disclosure includes any alterations and modifications to the illustrated embodiments and includes further applications of the principles of the disclosure as would normally occur to one skilled in the art to which this disclosure pertains.

For the purposes of the disclosure, the phrase “A and/or B” means (A), (B), or (A and B). For the purposes of the disclosure, the phrase “A, B, and/or C” means (A), (B), (C); (A and B); (A and C); (B and C); or (A, B and C).

The terms “comprising,” “including,” “having,” and the like, as used with respect to the embodiments of the disclosure, are synonymous.

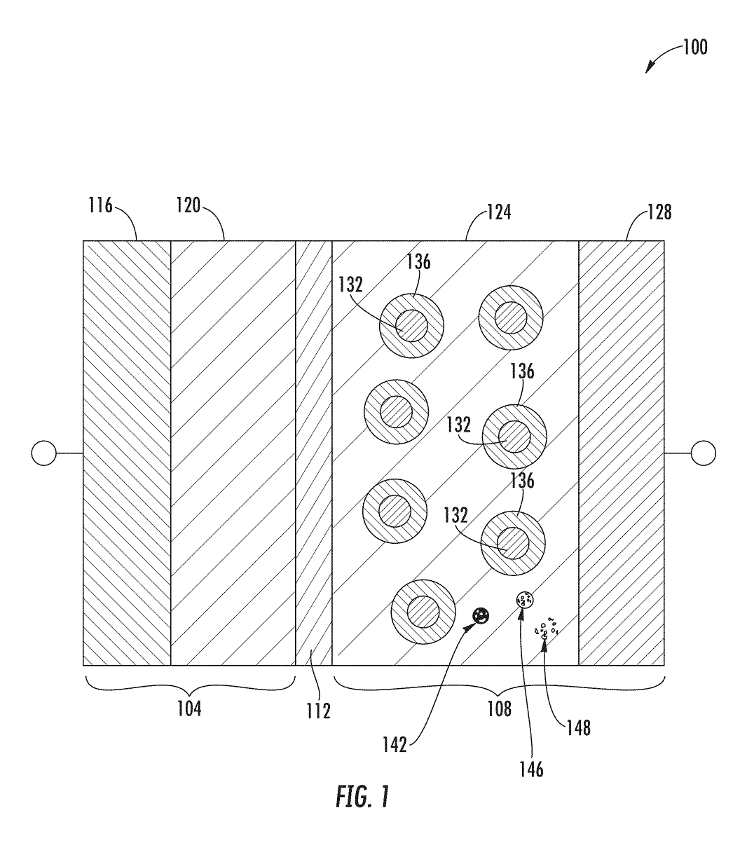

As shown in FIG. 1, a Li-ion battery cell 100 includes an anode 104, a cathode 108, and a separator 112 located between the anode 104 and the cathode 108. The anode 104 includes an anode current collector 116 and an anode electrode 120. The cathode 108 includes a cathode electrode 124 and a cathode current collector 128 that is typically formed from aluminium. As set forth below, the cathode electrode 124 is a solid-state composite material at an operating temperature of the battery cell 100 and includes a cathode active material 132 that is coated with a barrier layer 136, thereby making the cathode 108 a “coated cathode.” In FIG. 1, only the cathode active material 132 is coated with the barrier layer 136. The coated cathode active material 132 is fixed in position within the cathode electrode 124 by a catholyte material 142 (i.e. an electrolyte of the cathode 108 also referred to herein as ionically conducting material). As disclosed herein, the material of the barrier layer 136 is configured to ameliorate interfacial issues (i.e. degradation and high electrical resistance) between the cathode active material 132 and the material/composition of the catholyte 142. As a result of the barrier layer 136, the battery cell 100 having solid-state electrolytes is even more commercializable as compared to state of the art Li-ion battery cells.

The current collector 116 of the anode 104 is typically formed from copper when the anode electrode 120 includes anode active material comprising lithium metal. When the battery cell 100 is configured to provide power to an outside circuit (not shown) electrons flow out of the anode 104 through the current collector 116 to the outside circuit. Copper is typically a suitable material for forming the current collector 116 for most chemistries of the anode 104 including a solid-state anode electrode 120.

The anode electrode 120 is located between the current collector 116 and the separator 112. The anode electrode 120 includes anode active material (not shown) formed from lithium metal, for example. As compared to a graphite anode electrode of state of the art Li-ion cells, the lithium metal anode electrode 120 of the battery cell 100 eliminates additional flammable material.

With continued reference to FIG. 1, the separator 112 is an ionically conducting separator. The separator 112 is not electronically conductive and, therefore, blocks the passage of electrons therethrough. Lithium ions are free to pass through the separator 112 when moving from the anode 104 to the cathode 108 and when moving from the cathode 108 to the anode 104. The separator 112 is formed from a lithium-ion-conducting ceramic layer, a lithium-ion-conducting polymer layer, a composite of ceramic and polymer, or a multilayer structure consisting of alternating layers of one or more ceramics and one or more polymer layers and/or one or more composite layers. The separator 112 connects ionically the anode 104 and the cathode 108.

The cathode 108 includes the cathode electrode 124 and the cathode current collector 128. The cathode electrode 124 includes the coated active material 132, the catholyte material 142, (i.e. an ionically conductive material), electronically conductive material 146, and a binder material 148, each of which is a solid (i.e. is a solid-state material) at an operating temperature of the battery cell 100. The block diagram of FIG. 1 illustrates that the materials 142, 146, 148 and the particles of the coated active material 132 are typically evenly dispersed throughout the cathode electrode 124 in fixed positions. The composite cathode electrode 124 may be fully dense (i.e. zero porosity) or may have a porosity of as much as 50%. In one embodiment, an optimized porosity is below 20%. A cathode electrode 124 having a porosity of less than 20% is less than 20% empty space by volume.

The electronically conductive material 146, in one embodiment, includes carbon, carbon black, carbon fibers, or electronically conductive metal oxide. Any other suitably electronically conductive (i.e. electrically conductive) material or additive, such as an electronically conductive polymer, may be included in the cathode electrode 124 as the electronically conductive material 146.

The binder material 148, which is an optional material, is configured to hold the composition of the cathode electrode 124 together in a solid/rigid form. The cathode electrode 124 may include any suitable binding material as the binder material 148, such as a polymeric binder (e.g. polyvinylidene fluoride (PVDF)). In embodiments not including the binder material 148, the materials of the cathode electrode 124 may be pressed together into a solid mass or otherwise fixedly arranged and configured.

The ionically conductive material 142 (i.e. an ionically conducting solid-state electrolyte or catholyte) is, in one embodiment, as a sulfide ionic conductor or an ionically conductive polymeric electrolyte without sulfides. Specifically, the ionically conductive material 142 is formed from materials such as Li₁₀GeP₂S₁₂, Li₁₀SnP₂S₁₂, Li₁₁Si₂PS₁₂, Li₃PSₓ (x≥4), or argyrodite (Li₆PS₅X (X=Cl, Br, or I)). In the expression “Li₃PSₓ (x≥4),” the “x” in the expression is a number having a value greater than or equal to “4.” Similarly, in the expression “Li₆PS₅X,” the “X” in the expression is one of chlorine (“Cl”), bromine (“Br”), or iodine (“I”). The ionically conductive material 142, which is also referred to herein as an “ionic conductor” or a “catholyte” may also be formed from lithium-ion conducting garnets, lithium ion conducting sulfides (e.g., Li₂S—P₂S₅) or phosphates, Li₃P, lithium phosphorous oxynitride (“LiPON”), as well as polymeric electrolytes including lithium ion conducting polymer (e.g., poly(ethylene oxide) (“PEO”)), Li₇₋ₓLa₃TaₓZr₂₋₅ₓO₁₂, wherein 0≤X≤2, thio-LISICON, Li₁₀ conducting NASICON, Li₁₀GeP₂S₁₂, and lithium polysulfidophosphates.

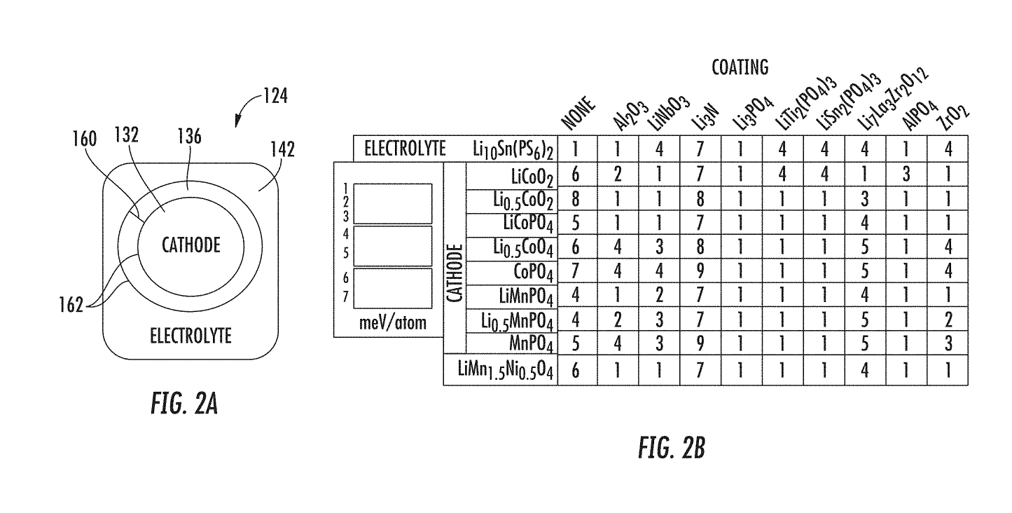

The ionically conductive material 142 of the cathode electrode 124 (also referred to herein as the catholyte material) has a high room temperature conductivity (typically >10⁻⁴ S/cm, sometimes >10⁻² S/cm); accordingly, the conductivity of the ionically conductive material 142 may be in the range of liquid electrolytes. The ionically conductive material 142 also has a high transference number (near unity) that eliminates some resistance and energy losses in the battery cell 100. Moreover, the ionically conductive material 142 prevents poor electrode 124 utilization due to concentration gradients, and is typically soft enough that the electrode 124 can be processed without heating the electrode 124 beyond approximately 100° C. The ionically conductive material 142 is evenly dispersed through the cathode electrode 124. The solid-state ionically conductive material 142 eliminates the flammable organic electrolyte used in state of the art Li-ion cells. Sulfide electrolytes (e.g. lithium tin phosphorus sulfide (“LSPS”)) are typically unstable against transition metal oxide cathode active materials 132. As set forth below, interlayers, such as the barrier layer 136, are beneficial in preventing reactions and forming stable interfaces 162 (FIG. 2A).

The cathode active material 132 is preferably a Li-insertion transition metal (“TM”) oxide material. In the one embodiment, the cathode active material 132 is in a powdered form including a plurality of particles of the cathode active material 132. Exemplary materials for forming the cathode active material 132 include LiNi0.8Co0.15Al0.05O2 (nickel cobalt aluminium (“NCA”)) or another TM oxide such as LiCoO₂, LiMn₂O₄, Li_{w}NiₓMn_{y}Co_{z}O₂, etc. In other embodiments, the cathode active material 132 may be another material such as a Li-insertion fluoride or oxyfluoride. TM oxides are typically preferred for the cathode active material 132, because they have high capacities (>150 mAh/g and sometimes >250 mAh/g), high voltages (˜3 to 5 V vs. lithium, typically), and high cycle life (>1000 cycles, sometimes >2000 cycles). The high capacity and voltage of the cathode active material 132, coupled with the high capacity and low voltage of the lithium metal anode electrode 120, results in a battery cell 100 energy density that is much higher than state of the art Li-ion cells (i.e., >300 Wh/kg and >600 Wh/L, sometimes >500 Wh/kg and >1000 Wh/L).

TM oxide cathode active materials 132 have numerous benefits as set forth above; however, TM oxide cathode active materials 132 are typically unstable against sulfide electrolytes, as may be included in the ionically conductive material 142 of the cathode electrode 124. That is, the cathode active material 132 should not come in direct physical contact with the electrolyte material(s) of the cathode electrode 124. To prevent the direct physical contact, the cathode electrode 124 includes the barrier layer 136 applied to the cathode active material 132. The barrier layer 136 is configure to isolate physically the cathode active material 132 from the other materials of the cathode electrode 124 (specifically the ionically conductive material 142), improves the long-term stability of the cathode electrode 124, and reduces the interfacial resistance between the ionically conductive material 142 and the cathode active material 132, which would otherwise be high due to reactions between the materials 132, 142.

In FIG. 1, the cathode active material 132 includes a plurality of sphere-like particles of powder, each particle of which is completely surrounded by an outer continuous shell of the barrier material of the barrier layer 136. The barrier layer 136 completely prevents the cathode active material 132 from contacting directly any portion of the ionically conductive material 142, such that the cathode active material 132 is completely physically isolated from the ionically conductive material 142. The coated cathode active material 132 is typically evenly dispersed throughout the materials of cathode electrode 124 in a desired concentration level. In other embodiments, the particles of cathode active material 132 have any size and shape that is suitable for accepting a continuous coating of the barrier material of the barrier layer 136.

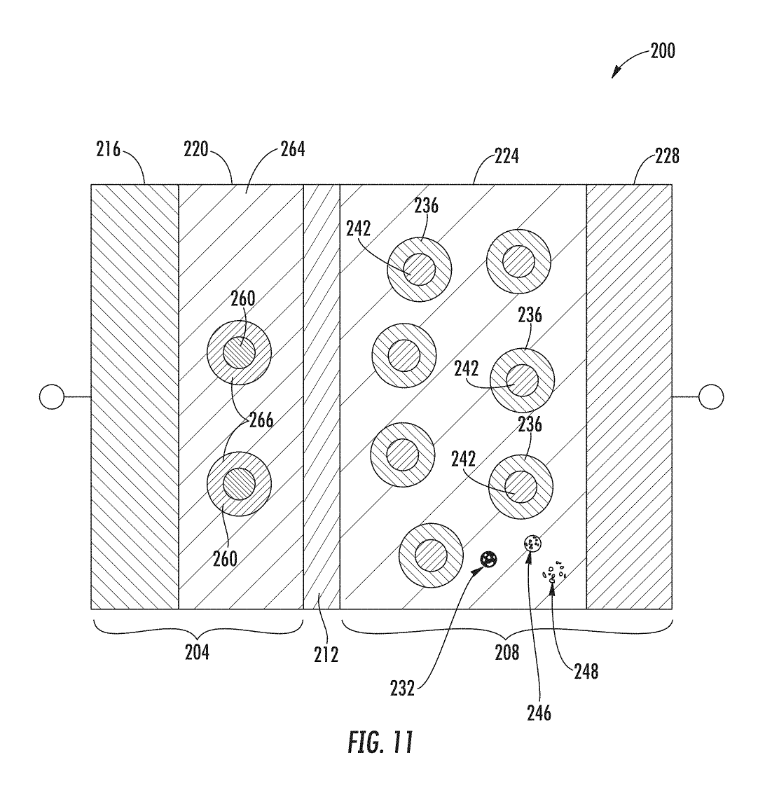

As shown in FIG. 2A, the barrier layer 136 is a sphere-like “shell” located around each sphere-like particle of the cathode active material 132. In one embodiment, the barrier layer 136 defines a radial thickness 160 that is less than a diameter of the particle of the cathode active material 132. In other embodiments, the thickness of the barrier layer is different (thicker or thinner) depending on the configuration of the cathode electrode 124. With reference to FIG. 1, the barrier layer 136 is included on only the cathode active material 132 and the barrier layer 136 does not surround the ionically conductive material 142. In other embodiments, the barrier layer 136 surrounds the ionically conductive material 142 and does not surround the cathode active material 132 (FIG. 11). In yet another embodiment, the barrier layer 136 surrounds the cathode active material 132 and the ionically conductive material 142.

The barrier layer 136 is typically a continuous or substantially continuous layer that extends completely around each particle of the cathode active material 132. The barrier layer 136 prevents physical contact between the cathode active material 132 and the ionically conductive material 142. Stated differently, the barrier layer 136 isolates physically the cathode active material 132 and the ionically conductive material 142 of the cathode electrode 124. The barrier layer 136 also spaces apart each particle of the cathode active material 132 from the ionically conductive material 142. The barrier layer 136, however, does ionically connect the cathode active material 132 and the ionically conductive material 142. That is, the barrier material of the barrier layer 136, in at least one embodiment, is highly ionically conductive to enable the free transfer of lithium ions therethrough. This includes enabling the coated cathode active material 132 to receive lithium ions from the ionically conductive material 142 through the barrier layer 136 and enabling the coated cathode material 132 to release lithium ions into the ionically conductive material 142 through the barrier layer 136. Moreover, in at least some embodiments, the barrier material of the barrier layer 136 has a low electronic conductivity to prevent the flow of electrons therethrough. Thus, in at least one embodiment, the barrier layer 136 prevents electron flow between the ionically conductive material 142 and the cathode active material 132 and prevents an electrical connection between the ionically conductive material 142 and the cathode active material 132.

The barrier layer 136 is configured to form at least two stable interfaces 162. The first stable interface 162 is formed between the barrier layer 136 and the cathode active material 132, and the second stable interface 162 is formed between the barrier layer 136 and the other materials of the cathode electrode 124 including the ionically conductive material 142. As used herein, a “stable interface” is an interface that is at least electrochemically stable. At the stable interfaces 162, the barrier material of the barrier layer 136 does not oxidize or reduce with the materials of the cathode active material 132, the ionically conductive material 142, the electronically conductive material 146, and the binder material 148. In some embodiments, the barrier layer 136 may react with other components of the cathode electrode 124 (i.e. the cathode active material 132, the ionically conductive material 142, the electronically conductive material 146, and the binder material 148); however, the product of the reaction is electrochemically stable at all interfaces and electronically insulating and, therefore, poses no detriment to a proper operation of the battery cell 100. Specifically, in one embodiment, the barrier material of the barrier layer 136 reacts with at least one of the active material 132 and the catholyte material (i.e. the ionically conductive material 142) and forms a product that is electrochemically stable with the barrier material, the active material 132, and the catholyte material 142.

A number of barrier materials suitable for forming the barrier layer 136 have been identified that are stable against the TM oxides of the cathode active material 132 and the ionically conductive material 142 of the cathode electrode 124. Exemplary materials suitable for forming the barrier layer 136 include LiNbO₂, Li₃PO₄, AlPO₄, carbon, Li₆B₃(Sb,Bi)O₉, Li₇(Bi,Sb,Nb)O₆, Li₄B₂O₅, Li₂Ta₄O₁₁, among others. These exemplary barrier materials were identified, in at least one instance, based on an identified minimum ionic channel size for conduction of lithium ions therethrough. Additional materials have also been determined to be stable for use as the barrier material of the barrier layer 136 including “rediscovered” garnets (e.g. cubic garnet-type Li₇La₃Zr₂O₁₂ (lithium lanthanum zironate (LLZO) ceramic electrolyte), NASICON-type LATP-class (i.e. lithium aluminium titanium phosphate) of materials, and materials from the thio-LISICON families. Exemplary barrier materials of this type include LiTi₂(PO₄)₃; LiSn₂(PO₄)₃; LiZr₂(PO₄)₃; LiBi(PO₃)₄; LiSb(PO₃)₄; LiTaO₃; LiSbO₃; LiNbO₃; LiBiP₂O₇; LiLa₅Ti₈O₂₄ (more generally, the lithium lanthanum titanium oxide (“LLTO”) solid electrolyte class); LiAlSiO₄; LiBiB₂O₅; and Li₂Mg₂(SO₄)₃. Test results indicate that barrier materials such as Li₃PO₄ may beneficially reduce the resistance to ion transfer to and from the surface of the TM oxide electrode material of the cathode electrode 124 (i.e. promote/increase ionic conductivity).

FIG. 2B is a chart identifying an exemplary electrolyte (i.e. the ionically conductive material 142) of the cathode electrode 124 in the first row and exemplary cathode active materials 132 in the other rows (i.e. rows 2-10). Tested materials for forming the barrier layer 136 are identified in the columns. Stable combinations of barrier material and cathode active material 132 are identified with numbers “1-4.” Combinations that are less stable are identified with numbers “5-9.” Lower numbers correspond to more stable combinations (i.e. stable interfaces) and higher numbers correspond to less stable combinations. Thus, a combination rated at “1” results in a more stable interface than a combination rated at “6.” Typically, the battery cell 100 is formed from combinations from the “stable” grouping (numbers 1-4). The particular circumstances and usage of the battery cell 100, however, may also permit the battery cell 100 to be formed from less stable groupings including those combinations identified with (numbers 5-9). Material such as carbon (“C”), Li₃PO4, and AlPO₄ have been identified as suitable candidates for stable combinations and stable interfaces.

The barrier layer 136 is typically applied to the cathode active material 132 powder in a processing step prior to combining the materials 132, 142, 146, 148 of the cathode electrode 124 using any suitable approach. For example, the material of the barrier layer 136 may be applied to the cathode active material 132 using sol-gel methods. Exemplary cathode active materials 132 to which a barrier layer 136 may be applied using sol-gel includes Li_{w}NiₓCo_{y}Mn_{z}O₂ (w=1, x=0.5, y=0.2, z=0.3, as well as other stoichiometries, such as w=1, x=0.8, y=0.05, z=0.15). The cathode active material 132 may also be coated with a barrier layer 136 through processes including chemical vapor deposition (e.g., for carbon), physical vapor deposition or sputtering, atomic layer deposition, pulsed laser deposition, electrodeposition, etc. Often the powder sample (“substrate”) of the cathode active material 132 is agitated using a rotating sample holder (e.g., rotating furnace) or acoustically agitated sample holder or fluidized bed in order to obtain more complete and uniform coverage of the cathode active material 132 with the material of the barrier layer 136, as well as to avoid agglomeration of cathode active material 132 during the selected coating process.

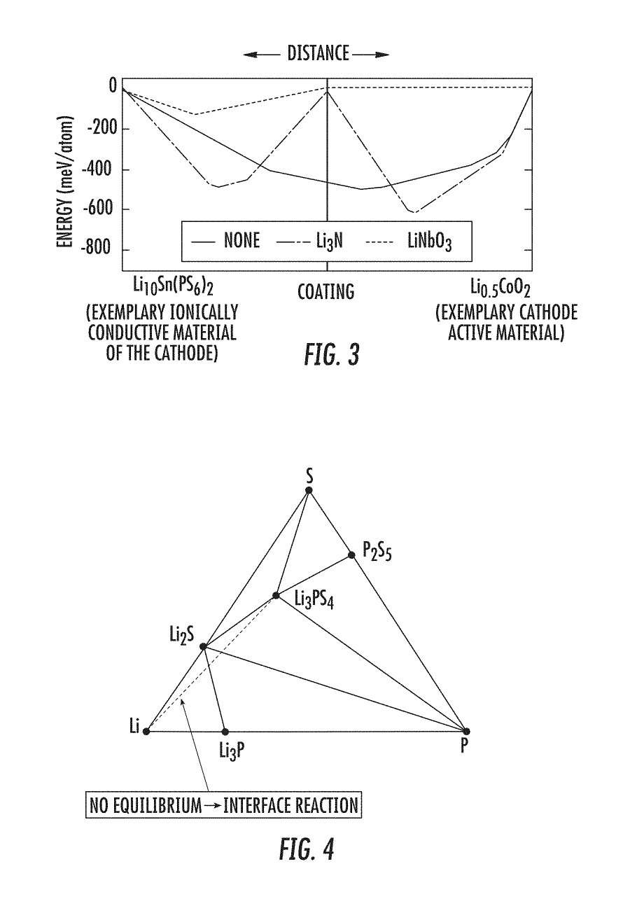

FIG. 3 illustrates an exemplary stability calculation illustrating the effects of no barrier layer 136, a barrier layer 136 formed from Li₃N, and a barrier layer 136 formed from LiNbO₃ on a cathode electrode 124 having the ionically conductive material 142 formed from Li₁₀Sn(PS₆)₂ and the cathode active material 132 formed from Li_{0.5}CoO₂. In FIG. 3, a reading of 0 meV/atom corresponds to a stable material or a stable interface, and increasingly negative energy values correspond to increasingly less stable materials or interfaces. Thus, a horizontal line at the 0 meV/atom value would identify a barrier material (i.e. a coating) that forms stable interfaces with the selected ionically conductive material 142 and the selected cathode active material 132. The solid line in FIG. 3 corresponding to no barrier layer 136 (i.e. None) shows that the selected ionically conductive material 142 and the selected cathode active material 132 form an unstable interface (energy of about −600 meV/atom) and therefore some type of barrier material is required. The barrier material formed from LiNbO₃ is very close to a horizontal line at the 0 meV/atom value and is, therefore, a particularly suitable barrier material for the barrier layer 136 resulting in stables interfaces 162. Whereas, the barrier material formed from Li₃N results in even more instability than with no barrier material at all (energy of about −650 meV/atom) and is typically an unsuitable barrier material for the selected ionically conductive material 142 and the selected cathode active material 132.

With reference to FIG. 4, a phase diagram is shown for various compounds/materials formed from lithium, sulfur, and phosphorous. A solid line connection corresponds to materials that form stable interfaces 162. Whereas, materials that are not connected or are connected by a broken line form unstable interfaces. For example, as shown by the broken line connecting lithium to Li₃PS₄, there is no equilibrium and these materials when brought together form an unstable interface that may result in an interface reaction through oxidation and/or reduction.

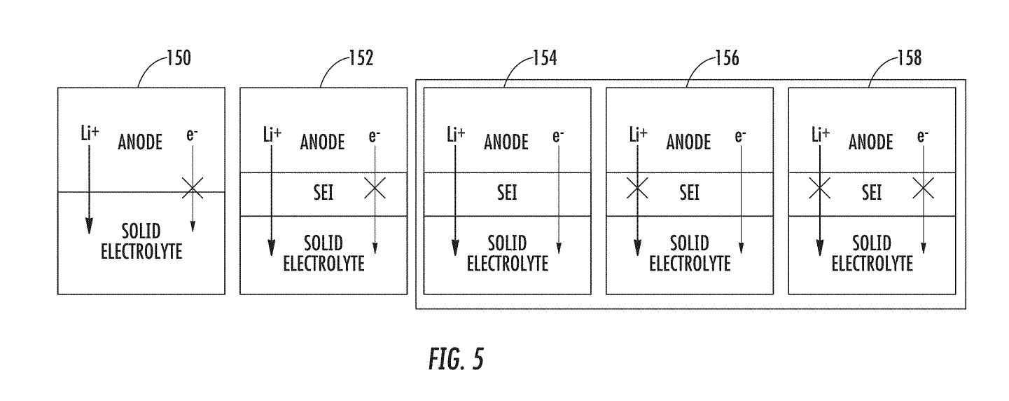

FIG. 5 illustrates a stability prediction tool with a design rule selected to predict stable solid electrolyte interface (“SEI”) interphases. In the example of FIG. 5, a stable interface between two materials/compounds occurs if product phases conduct lithium ions but not electrons. The illustrated stability prediction tool is also valid in evaluating voltage stability. As shown in FIG. 5, five design approaches 150, 152, 154, 156, 158 are shown for an anode and a solid electrolyte. The design approaches are equally applicable to the selection of a barrier material of a barrier layer 136 in a cathode 124. Design approach 150 illustrates no reaction and a stable interface that passes Li+ ions (i.e. is ionically conductive) and prevents the passage of electrons (i.e. is not electronically conductive). Design approach 152 illustrates a stable SEI that passes lithium ions and prevents the passage of electrons. Design approach 154 shows an unstable SEI that passes lithium ions but that undesirably enables the passage of electrons (i.e. is electronically conductive). Design approaches 156 and 158 illustrate high interference resistance (i.e. low or no ionic conductivity). Of the five design approaches, approaches 150 and 152 are typically utilized in fabricating the battery cell 100.

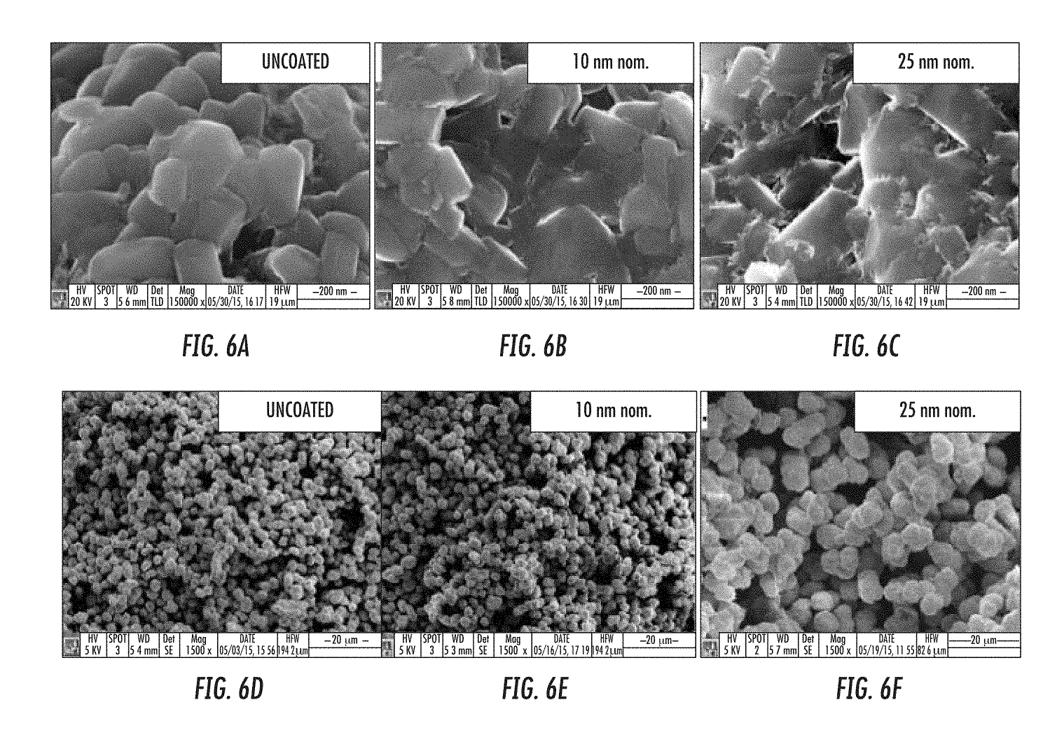

FIGS. 6A through 6F illustrate scanning electron microscope (“SEM”) views of samples of the cathode active material 132 before and after being coated with the barrier material of the barrier layer 136. Specifically, FIGS. 6A and 6D show the cathode active material 132 in an uncoated configuration. FIGS. 6B and 6E show the cathode active material 132 having the material of the barrier layer 136 applied thereto at a nominal thickness of about 10 nanometers (10 nm). FIGS. 6C and 6F show the cathode active material 132 having the material of the barrier layer 136 applied thereto at a nominal thickness of about 25 nanometers (25 nm). The cathode active material 132 illustrated and coated in FIGS. 6A-6F is NCM, and the material of the barrier layer 136 is Li₃PO₄. FIGS. 6B, 6C, 6E, and 6F show subtle but consistent morphological changes with increasing thickness of the barrier layer 136 and similar aggregation.

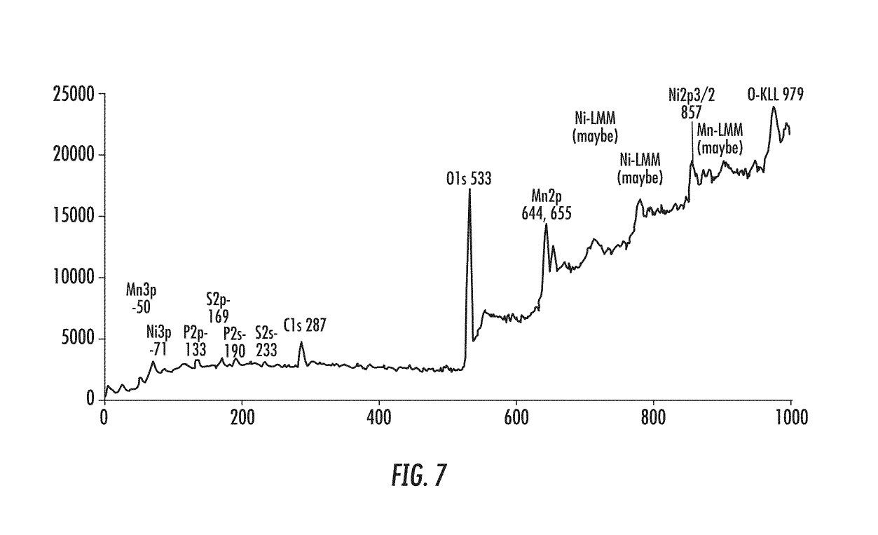

FIG. 7 illustrates an XPS spectrum (x-ray photoelectron spectroscopy spectrum) of the coated material illustrated in FIGS. 6B, 6C, 6E, and 6F. In particular, FIG. 7 is an XPS spectrum of cathode active material 132 provided as NCM and the barrier layer 136 material provided as Li₃PO₄. As shown in FIG. 7, the barrier layer 136 applied to the cathode active material 132 substantially covers all of the NCM, but does not completely cover the NCM, as shown by the presence of the material of the NCM material in the XPS spectrum.

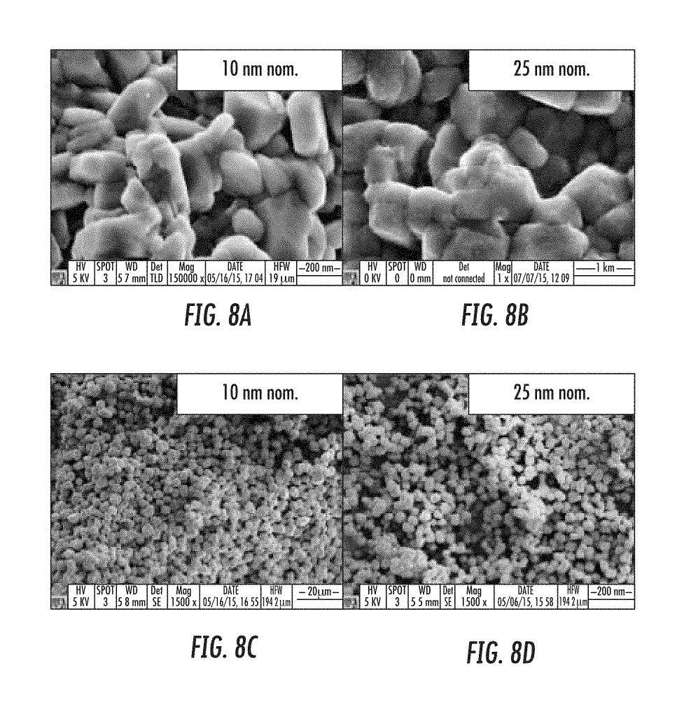

FIGS. 8A through 8D illustrate additional SEM views of samples of the cathode active material 132 after being coated with the material of the barrier layer 136. The cathode active material 132 is NCM and the material of the barrier layer 136 is LiNbO₃. FIGS. 8A and 8C show the cathode active material 132 having the material of the barrier layer 136 applied thereto at a nominal thickness of about 10 nanometers (10 nm). FIGS. 8B and 8D show the cathode active material 132 having the material of the barrier layer 136 applied thereto at a nominal thickness of about 25 nanometers (25 nm). FIGS. 8A-8D illustrate subtle but consistent morphological changes with increasing thickness and similar aggregation.

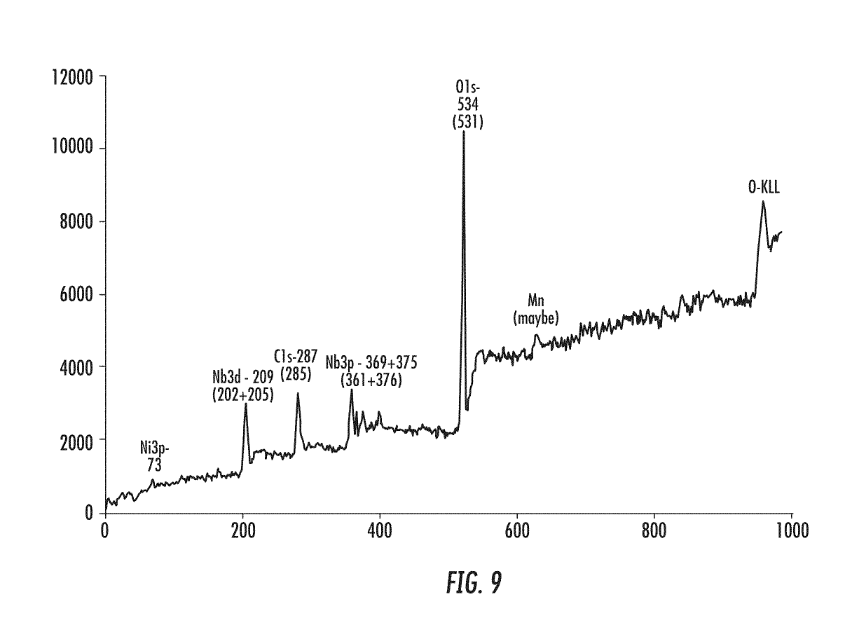

FIG. 9 illustrates an XPS spectrum of the material illustrated in FIGS. 8A-8D. In particular, FIG. 9 is an XPS spectrum of NCM cathode active material 132 and a LiNbO₃ barrier layer 136. The coating applied to the cathode active material 132 is substantially continuous (even more so than the coating of FIGS. 6B, 6C, 6E, and 6F) as shown by the almost completely diminished material of the cathode active material 132 substrate in the XPS spectrum. The peak of Nb₃d indicates mixed LiNbO₃ and Nb₂O₅.

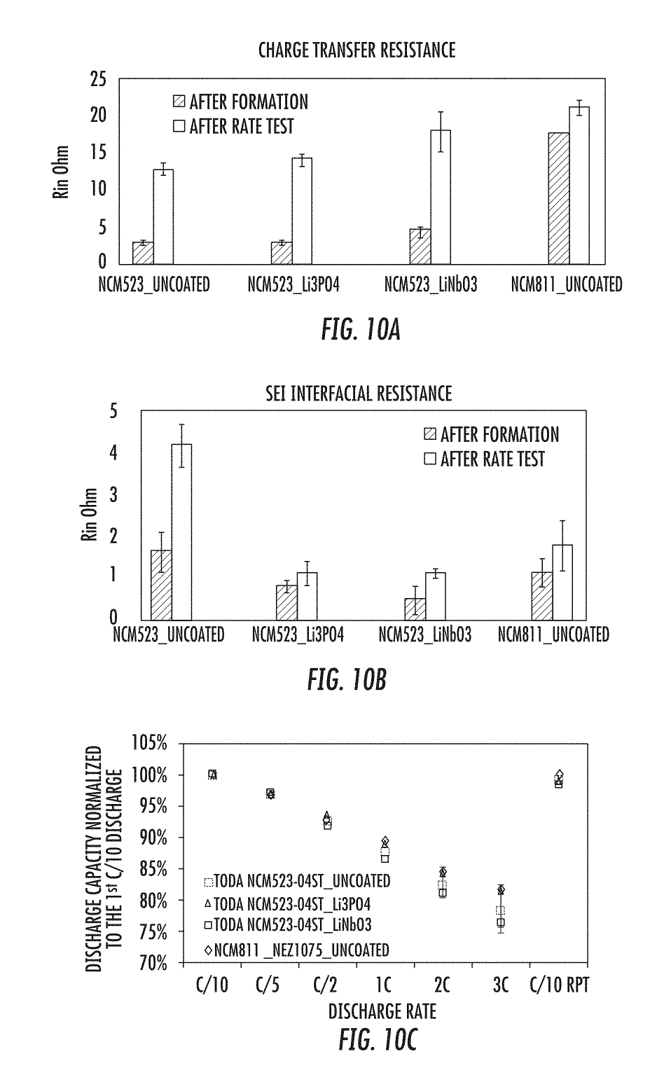

FIGS. 10A-10C illustrate preliminary electrochemical data for different coated cathode active material 132 powders in liquid battery cells. Specifically, FIG. 10A is a chart of charge transfer resistance for cathode active materials 132 including NCM523 in an uncoated configuration, NCM523 coated with barrier material Li₃PO₄, NCM523 coated with barrier material LiNbO₃, and cathode active material 132 NCM811 in an uncoated configuration. The resistance in ohms is charted for each of the materials after formation (shown on the left for each material) and after rate test (shown on the right for each material). For each material, the resistance increases after the rate test. Moreover, FIG. 10A shows that coating the cathode active material 132 of NCM523 in either barrier materials Li₃PO₄ or LiNbO₃ only marginally increases the charge transfer resistance as compared to uncoated NCM523, thereby further establishing Li₃PO₄ or LiNbO₃ as suitable barrier materials for the barrier layer 136. FIG. 10B is a chart of SEI interfacial resistance for the same materials of FIG. 10A. FIG. 10B shows, among other things, that the resistance of the NCM523 is reduced in response to the NCM523 being coated with Li₃PO₄ or LiNbO₃. The reduction in SEI interfacial resistance further establishes Li₃PO₄ and LiNbO₃ as suitable barrier materials for the barrier layer 136 that each result in a stable interface with the cathode active material 132 NCM523. FIG. 10C is a chart illustrating discharge capacity normalized to the first C/10 discharge versus discharge rate for the same materials of FIGS. 10A and 10B.

As shown in FIG. 11, in another embodiment, a battery cell 200 includes a barrier layer 236 that coats particles of the ionically conductive material 242 of the cathode electrode 224 instead of coating particles of the cathode active material 232, as in the battery cell 100 of FIG. 1. The battery cell 200 also includes anode active material 260 of the anode electrode 220 that is coated with a barrier layer 268. The battery cell 200 includes an anode 204, a cathode 208, and a separator 212 located between the anode 204 and the cathode 208. The anode 204 includes an anode current collector 216 and an anode electrode 220. The cathode 208 includes a cathode electrode 224 and a cathode current collector 228 that is typically formed from aluminium. The cathode electrode 224 is a solid composite material including cathode active material 232, ionically conductive material 242, electronically conductive material 246, and binding material 248. The ionically conductive material 242 is coated with the barrier material of the barrier layer 236 to prevent direct contact between the ionically conductive material 242 and the cathode active material 232. The material of the barrier layer 236 is configured to ameliorate interfacial issues (i.e. degradation and high electrical resistance) between the cathode active material 232 and the ionically conductive material 242. As a result of the barrier layer 236, the battery cell 200 having solid-state electrolytes is even more commercializable as compared to state of the art Li-ion battery cells.

The anode electrode 220 is a composite solid-state material including at least an anode active material 260 and an anolyte 264. The anode active material 260 is coated with a barrier layer 268 that prevents direct physical contact between the anode active material 260 and the anolyte 264. Suitable materials for forming the barrier layer 268 include Li-insertion anode material (or materials) such as graphite, silicon, tin, and the like. Thus, the composite anode electrode 220 may be formed from lithium metal powder that is coated with graphite, silicon, and/or tin, for example, to prevent direct physical contact between the lithium metal powder and the anolyte 264, the current collector 216, and the separator 212. Except for the differences noted above, the battery cell 200 is substantially the same as the battery cell 100.

While the disclosure has been illustrated and described in detail in the drawings and foregoing description, the same should be considered as illustrative and not restrictive in character. It is understood that only the preferred embodiments have been presented and that all changes, modifications, and further applications that come within the spirit of the disclosure are desired to be protected.

What is claimed is:

1. A solid-state lithium-ion battery comprising:
an anode;
a cathode including an active material, a catholyte material, and a barrier layer coating only the active material, the barrier layer configured to isolate physically the active material from direct contact with the catholyte material and to connect ionically the active material and the catholyte material; and
a separator located between the anode and the cathode and configured to connect ionically the anode and the cathode and to isolate electronically the anode and the cathode.

2. The solid-state battery of claim 1, wherein the active material is configured to accept lithium ions through the barrier layer and to release lithium ions through the barrier layer.

3. The solid-state battery of claim 1, wherein the barrier layer prevents electron flow between the catholyte material and the active material.

4. The solid-state battery of claim 1, wherein:
the active material is configured as a plurality of active material particles each having a fixed position in the cathode, and
each active material particle of the plurality of active material particles is coated with the barrier layer, such that each active material particle is spaced apart from the catholyte material by the barrier layer.

5. The solid-state battery of claim 1, wherein:
a first stable interface is formed between the active material and the barrier layer, and
a second stable interface is formed between the barrier layer and the catholyte material.

6. The solid-state battery of claim 1, wherein:
the barrier layer is formed from Li₃PO₄, and
the active material is formed from nickel cobalt manganese oxide (“NCM”).

7. The solid-state battery of claim 6, wherein the catholyte material is formed from a lithium ion conducting polymer.

8. The solid-state battery of claim 1, wherein:
the active material is a solid at an operating temperature of the battery cell,
the catholyte material is a solid at the operating temperature of the battery cell, and
the barrier layer is formed from a barrier material that is a solid at the operating temperature of the battery cell.

9. A coated cathode of a solid-state energy storage device, comprising:
a catholyte material;
an active material dispersed through the catholyte material; and
a barrier layer coating only one of the catholyte material and the active material, the barrier layer configured to isolate physically the active material from direct contact with the catholyte material and to connect ionically the active material and the catholyte material.

10. The coated cathode of claim 9, wherein the active material is configured to accept lithium ions through the barrier layer and to release lithium ions through the barrier layer.

11. The coated cathode of claim 9, wherein the barrier layer prevents electron flow between the catholyte material and the active material.

12. The coated cathode of claim 9, wherein:
the active material is configured as a plurality of active material particles each having a fixed position relative to the catholyte material, and
each active material particle of the plurality of active material particles is coated with the barrier layer, such that each active material particle is spaced apart from the catholyte material by the barrier layer.

13. The coated cathode of claim 9, wherein:
a first stable interface is formed between the active material and the barrier layer, and
a second stable interface is formed between the barrier layer and the catholyte material.

14. The coated cathode of claim 10, wherein:
the first stable interface passes lithium ions and prevents passage of electrons, and
the second stable interface passes lithium ions and prevents passage of electrons.

15. The coated cathode of claim 9, wherein:
the barrier layer is formed from Li₃PO₄, and
the active material is formed from nickel cobalt manganese oxide (“NCM”).

16. The coated cathode of claim 15, wherein the catholyte material is formed from a lithium ion conducting polymer.

17. The coated cathode of claim 9, wherein:
the active material is a solid at an operating temperature of the energy storage device,
the catholyte material is a solid at the operating temperature of the energy storage device, and
the barrier layer is formed from a barrier material that is a solid at the operating temperature of the energy storage device.

18. The coated cathode of claim 9, wherein the barrier material reacts with at least one of the active material and the catholyte material and forms a product that is electrochemically stable with the barrier material, the active material, and the catholyte material.

19. The coated cathode of claim 9, wherein the catholyte material, the active material, and the barrier layer have a porosity of up to 50%.
